(19) United States
(12) Patent Application Publication
(10) Pub. No.: US 2015/0160534 A1
(43) Pub. Date: Jun. 11, 2015

(54) LENS CAP

(71) Applicant: CHUNG JEN CHANG, TAICHUNG CITY (TW)

(72) Inventor: CHUNG JEN CHANG, TAICHUNG CITY (TW)

(21) Appl. No.: 14/098,397

(22) Filed: Dec. 5, 2013

(51) Int. Cl. G03B 11/04

(52) U.S. Cl. CPC G03B 11/043

(57) ABSTRACT

A lens cap assembly includes a hood device, a connecting ring and a ferrule device. The connecting ring is used to rotationally connect the hood device to a barrel of a lens assembly. The ferrule device is movable between a shrunk position and an expanded position. In the shrunk position, the ferrule device prevents the hood device from rotation on the barrel. In the expanded position, the ferrule device allows the rotation of the hood device on the barrel.

### BACKGROUND OF INVENTION

1. Field of invention

The present invention relates to a and, more particularly, to a

2. Related Prior Art

A lens is an important element for a projector or a camera. A clear and clean lens enables a projector to project a clear image or a camera to take a clear picture. Hence, a lens must be carefully handled and protected so that it will not be damaged and/or contaminated.

U.S. Pat. No. 7775671 discloses a cap set 3 for a lens set 2. The lens set 2 includes a body 21 formed with an edge 210. The cap set 3 includes a seat 320 and a cap 310. The seat 320 is detachably attached to the edge 210. The cap 310 is detachably attached to the seat 320. To use the lens set 2, at least the cap 310 is detached from the seat 320. Then, the cap 310 is simply put in a pocket. To detach the cap 310 from the seat 320 and put the cap 310 in the pocket immediately before a user wants to use the lens set 2 might cost the user failure to take a splendid instantaneous picture in time. On the other hand, to detach the cap 310 from the seat 320 long before the user wants to use the lens set 2 would increase the risk of damaging and/or contaminating the lens set 2.

U.S. Patent Publication No. 2013-0148217 discloses a cap unit 50 that includes a mounting part 51 and four barriers 52. The mounting part 51 is connected to a lens barrel 13. The barriers 52 are pivotally connected to the mounting part 51. The barriers 52 are biased by springs. A linearly-moving cylinder 41 is inserted in the lens barrel 13. The linearly-moving cylinder 41 can extend from the lens barrel 13 to push the barriers 52 to a position for opening the lens barrel 13. The linearly-moving cylinder 41 can be withdrawn into the lens barrel 13 to allow the springs to return the barriers 52 into the original for shutting the lens barrel 13. It is however difficult to place the barriers 52 in a desired position about an axis of the lens barrel 13 and firmly keep the cap unit 50 on the lens barrel 13 at the same time. Moreover, the structure of the cap unit 50 is complicated.

The present invention is therefore intended to obviate or at least alleviate the problems encountered in the prior art.

### SUMMARY OF INVENTION

It is the primary objective of the present invention to provide a lens cap assembly.

To achieve the foregoing objective, the lens cap assembly includes a hood device, a connecting ring and a ferrule device. The connecting ring is used to rotationally connect the hood device to a barrel of a lens assembly. The ferrule device is movable between a shrunk position and an expanded position. In the shrunk position, the ferrule device prevents the hood device from rotation on the barrel. In the expanded position, the ferrule device allows the rotation of the hood device on the barrel.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a lens cap assembly according to the preferred embodiment of the present invention;

FIG. 2 is an exploded view of the lens cap assembly shown in FIG. 1;

FIG. 3 is an enlarged partial view of the lens cap assembly shown in FIG. 2;

FIG. 4 is a cross-sectional view of the lens cap assembly shown in FIG. 1;

FIG. 5 is an enlarged partial perspective view of the lens cap assembly shown in FIG. 4;

FIG. 6 is a cross-sectional view of the lens cap assembly shown in FIG. 5;

FIG. 7 is a cross-sectional view of the lens cap assembly in another position than shown in FIG. 6;

FIG. 8 is a cross-sectional view of the lens cap assembly in another position than shown in FIG. 4;

FIG. 9 is an enlarged partial perspective view of the lens cap assembly shown in FIG. 8;

FIG. 10 is a cross-sectional view of the lens cap assembly shown in FIG. 9;

FIG. 11 is a perspective view of the lens cap assembly in another position than shown in FIG. 8;

FIG. 12 is a front view of the lens cap assembly of FIG. 11;

FIG. 13 is a cross-sectional view of the lens cap assembly shown in FIG. 12;

FIG. 14 is another perspective view of the lens cap assembly shown in FIG. 11;

FIG. 15 is a cross-sectional view of the lens cap assembly shown in FIG. 14;

FIG. 16 is a perspective view of the lens cap assembly in another position than shown in FIG. 14; and

FIG. 17 is a cross-sectional view of the lens cap assembly shown in FIG. 16.

### DETAILED DESCRIPTION OF PREFERRED EMBODIMENT

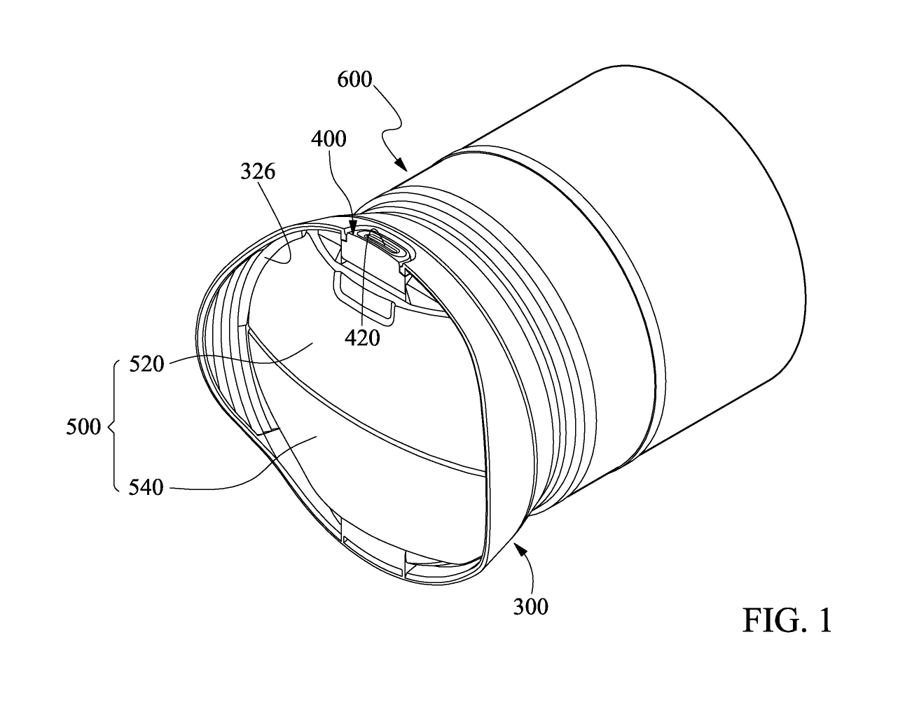

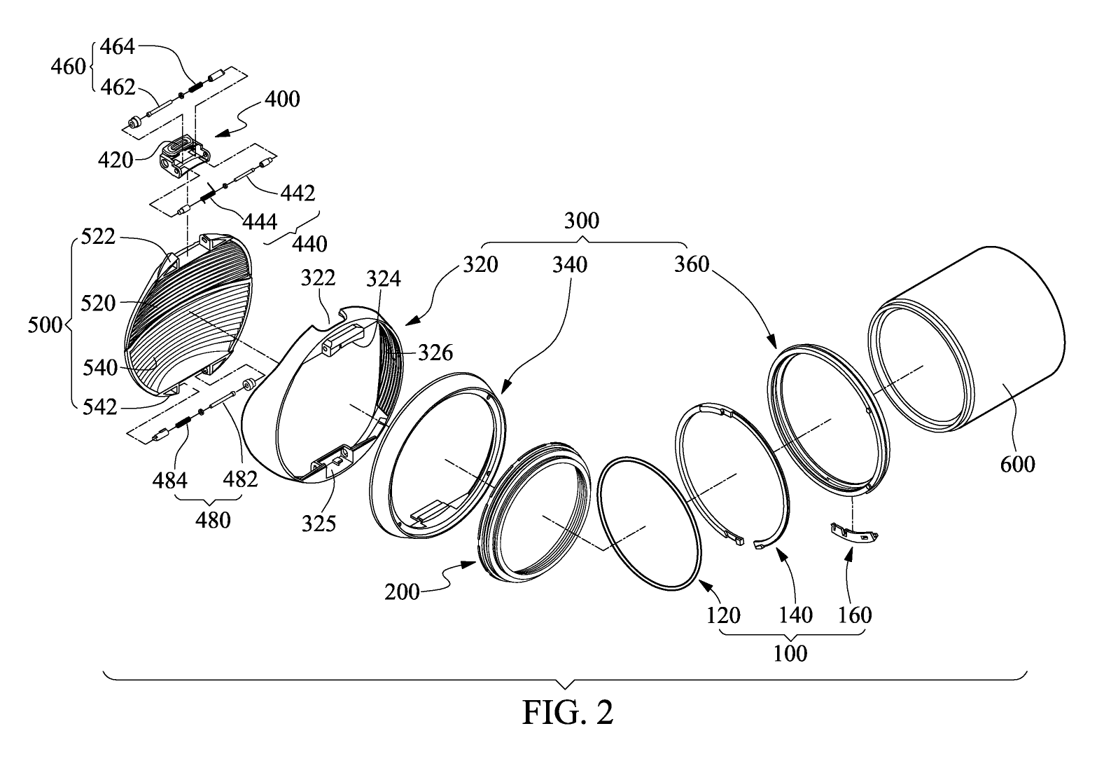

Referring to FIGS. 1 through 3, a lens cap assembly includes a ferrule device 100, a connecting ring 200, a hood device 300, a button device 400 and a shield device 500 according to the preferred embodiment of the present invention. The connecting ring 200 is non-rotationally connected to a barrel 600 of a lens assembly. The ferrule device 100 is rotationally placed on the connecting ring 200. The hood device 300 is connected to the ferrule device 100 so that they are rotatable together. The shield device 500 includes two shields 520 and 540. The first shield 520 is pivotally connected to the button device 400, which is pivotally connected to the hood device 300. The second shield 540 is pivotally connected to the hood device 300.

Normally, the shields 520 and 540 are in a closing position to close the barrel 600. The button device 400 can be pushed to allow movement of the shields 520 and 540 into an opening position to open the barrel 600. The ferrule device 100 can be placed in a shrunk position for keeping the hood device 300 in position on the connecting ring 200. The ferrule device 100 can be switched into an expanded position to allow the hood device 300 to rotate on the connecting ring 200 to bring the shields 520 and 540 into any desired position about an axis of the barrel 600.

The connecting ring 200 includes a stepped configuration along the axis thereof. That is, the connecting ring 200 includes a small section and a large section in external diameter. The connecting ring 200 includes a thread 220 extending on an external face of the small section and a groove 260 extending on an external face of the large section. The thread 220 is engaged with a thread formed on an internal face of the barrel 600 to attach the connecting ring 200 to the barrel 600.

The ferrule device 100 includes a sealing ring 120, a ferrule 140 and a lock 160. The sealing ring 120 is placed in the groove 260 before the ferrule 140.

The ferrule 140 is a C-shaped element formed with two ends. The ferrule 140 further includes a pivot 142 near the first end, a wedge 146 near the second end, a cutout 148 near the wedge 146, and a recess 144 in communication with the cutout 148.

The lock 160 is an arched element formed with two ends. The lock 160 includes an aperture 162 near the first end, a boss 166 at the second end, and a wedge 164 near the boss 166. The lock 160 includes a slit 168 near the second end so that the lock 160 is formed with an elastic leaf 169 on which the boss 166 is formed. The elastic leaf 169 is elastically pivotable so that the boss 166 is elastically movable.

The aperture 162 receives the pivot 142 to pivotally connect the lock 160 to the ferrule 140. The lock 160 is pivotable between a locking position and a releasing position. During the pivoting of the lock 160 into the locking position from the releasing position, the wedge 164 is for sliding on the wedge 146 to bring the first and second ends of the ferrule 140 toward each other. The boss 166 can be inserted in the recess 144 to retain the lock 160 in the locking position. The elastic leaf 169 is intended to facilitate the movement of the boss 166 into and out of the recess 144.

The hood device 300 includes three rings 320, 340 and 360. The first ring 320 includes a cutout 322 made in a front edge, two chambers 324 and 325 formed on an internal face, and two arched ribs 326 formed on the internal face. The arched ribs 326 are located closer to the chamber 324 than the chamber 325. The height of each of the arched ribs 326 measured from the internal face of the first ring 320 gets smaller as it extends further from the chamber 324.

The second ring 340 is attached to the first ring 320 by ultrasonic waves for example. The second ring 340 includes two tabs (only one is shown and not numbered) for closing the chambers 324 and 325, respectively.

The third ring 360 includes a slot 362 for receiving the lock 160. Thus, the third ring 360 is rotatable together with the lock 160. That is, the third ring 360 is rotatable together with the ferrule 140. The third ring 360 is attached to the second ring 340 by ultrasonic waves for example. Thus, the hood device 300 is rotatable together with the ferrule device 100.

The button device 400 includes a button 420 and a shaft unit 440. The button 420 is a hollow element. A first portion of the button 420 is placed in the chamber 324. The first portion of the button 420 is pivotally connected to the chamber 324 by the shaft unit 440 that is placed in the chamber 324. A second portion of the button 420 is placed in the cutout 322. The button 420 is movable between a normal position and a pushed position. The shaft unit 44 tends to move the button 420 to the normal position. The shaft unit 440 includes a shaft 442 and a torque spring 444. The shaft unit 440 will not be described in detail for being conventional.

The shield 520 is formed with two lugs 522. The lugs 522 are placed on two opposite sides of the button 420. The lugs 522 are pivotally connected to the second portion of the button 420 by a shaft unit 460 that is placed in the second portion of the button 420. The shaft unit 460 tends to pivot the shield 520 into the opening position, i.e., from the first ring 320. The shaft unit 460 includes a shaft 462 and a torque spring 464. The shaft unit 460 will not be described in detail for being conventional.

The shield 540 is formed with two lugs 542. The lugs 542 are placed on two opposite sides of the chamber 325. The lugs 542 are pivotally connected to the chamber 325 by a shaft unit 480 that is placed in the chamber 325. The shaft unit 480 tends to pivot the shield 540 into the opening position, i.e., from the first ring 320. The shaft unit 480 includes a shaft 482 and a torque spring 484. The shaft unit 480 will not be described in detail for being conventional.

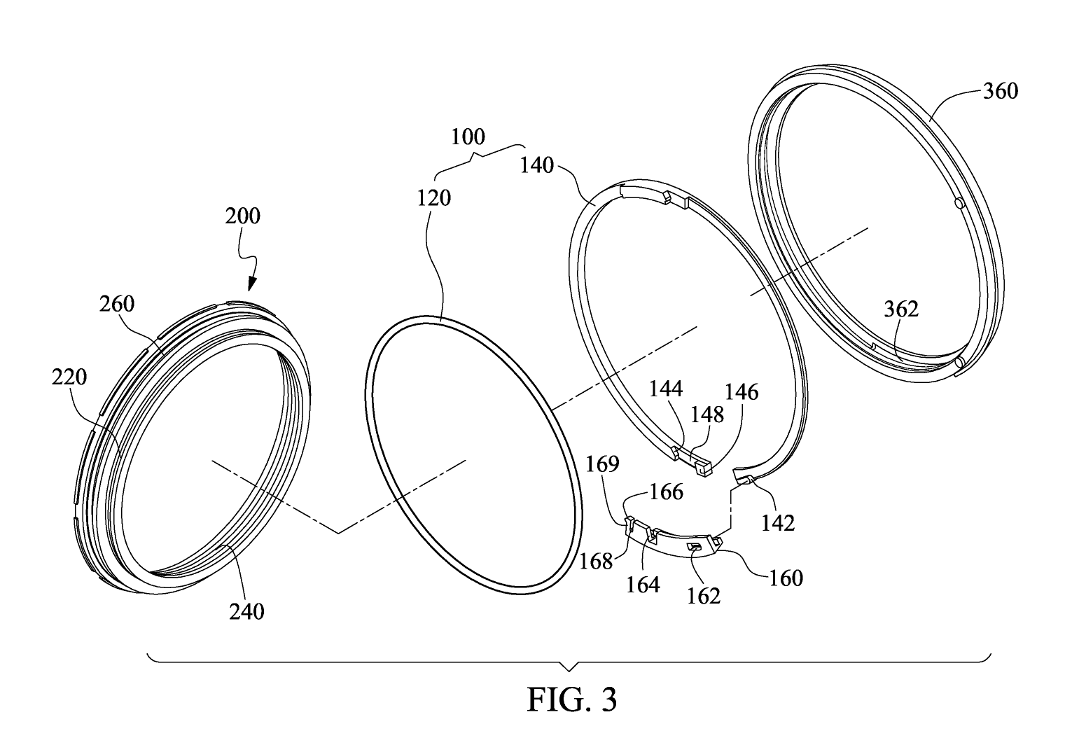

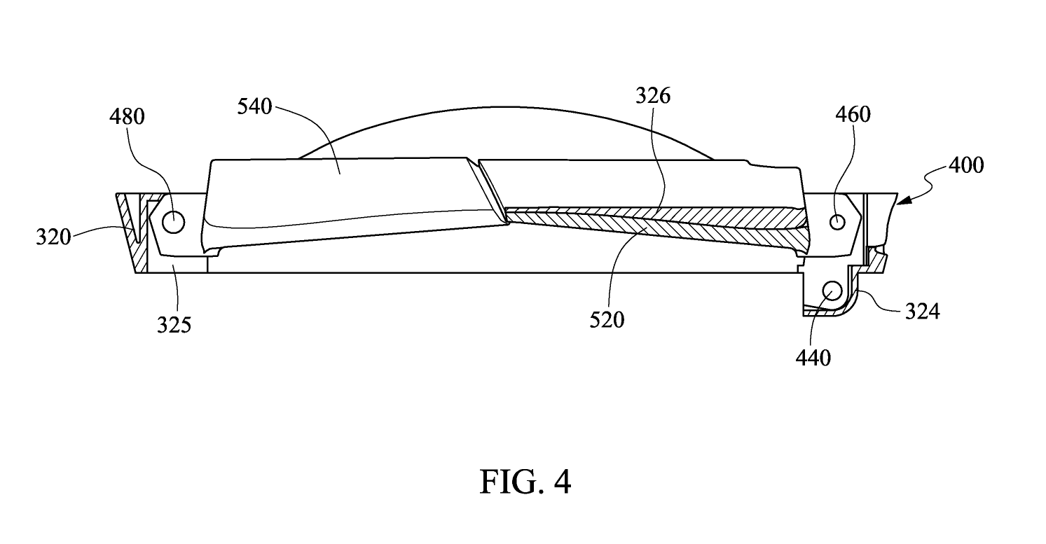

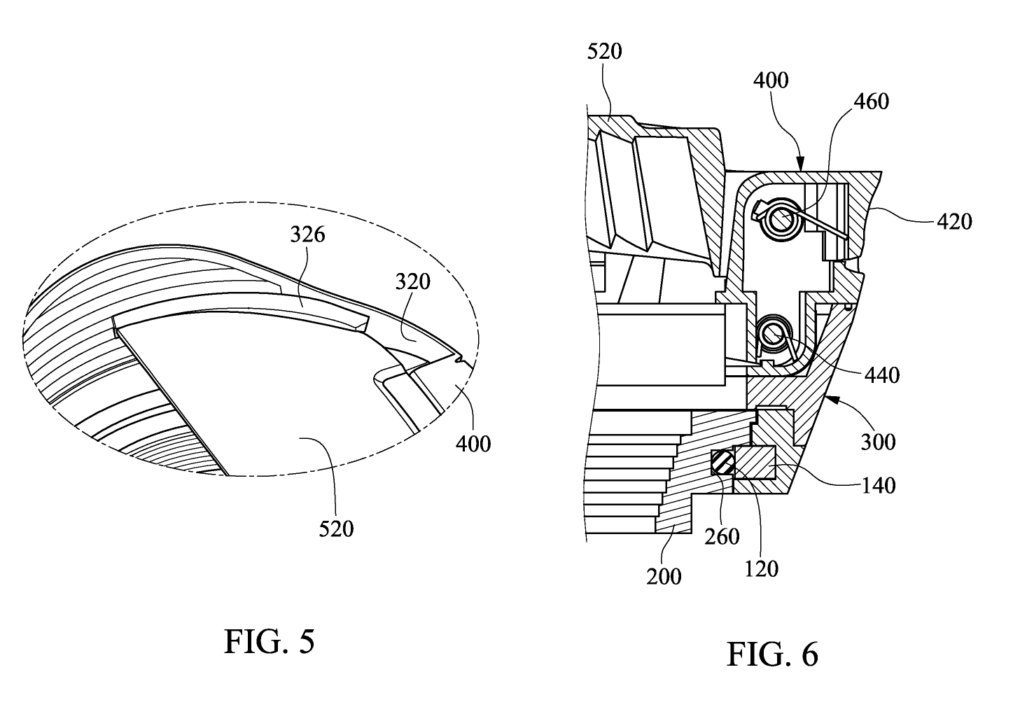

Referring to FIGS. 4 through 6, a front edge of the shield 540 is placed beneath a front edge of the shield 520. Two lateral edges of the shield 520 are placed beneath the arched ribs 326. That is, the shield 520 is in the closing position. The button device 400 is retained in the normal position by the shaft unit 440. Hence, the shield 520 is retained in the closing position.

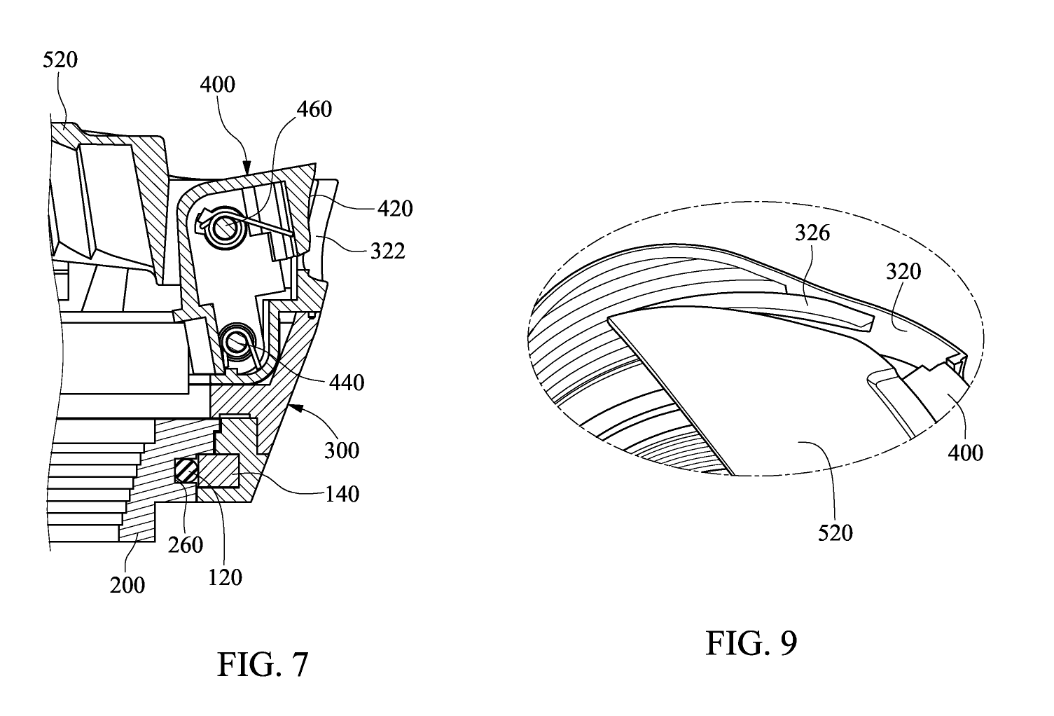

Referring to FIG. 7, the button device 400 is pushed, i.e., in the pushed position. Thus, the shield 520 is moved toward the shield 540 so that the lateral edges of the shield 520 are moved beyond the arched ribs 326. Now, the shield 520 is allowed to pivot from the first ring 320 of the hood device 300.

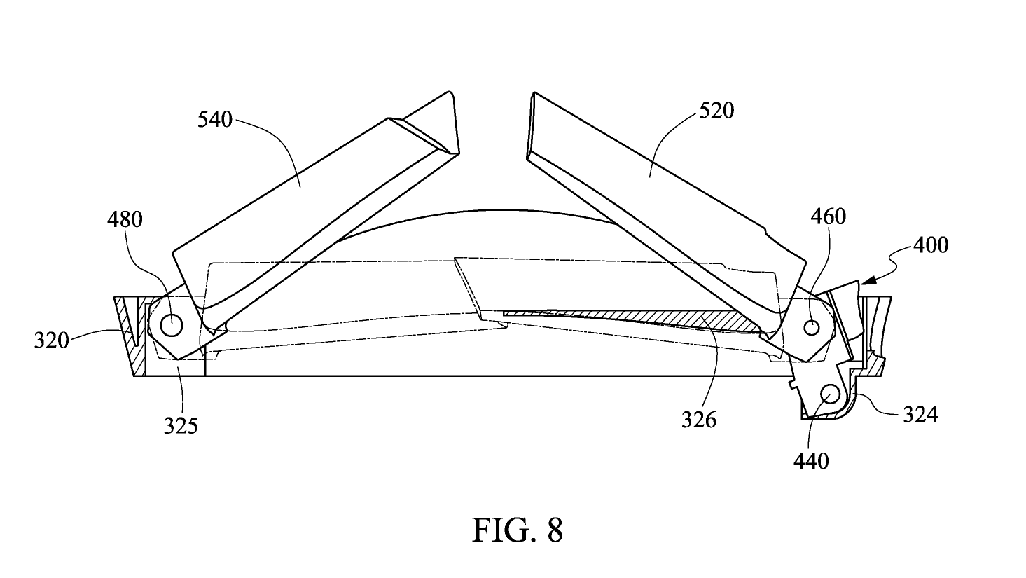

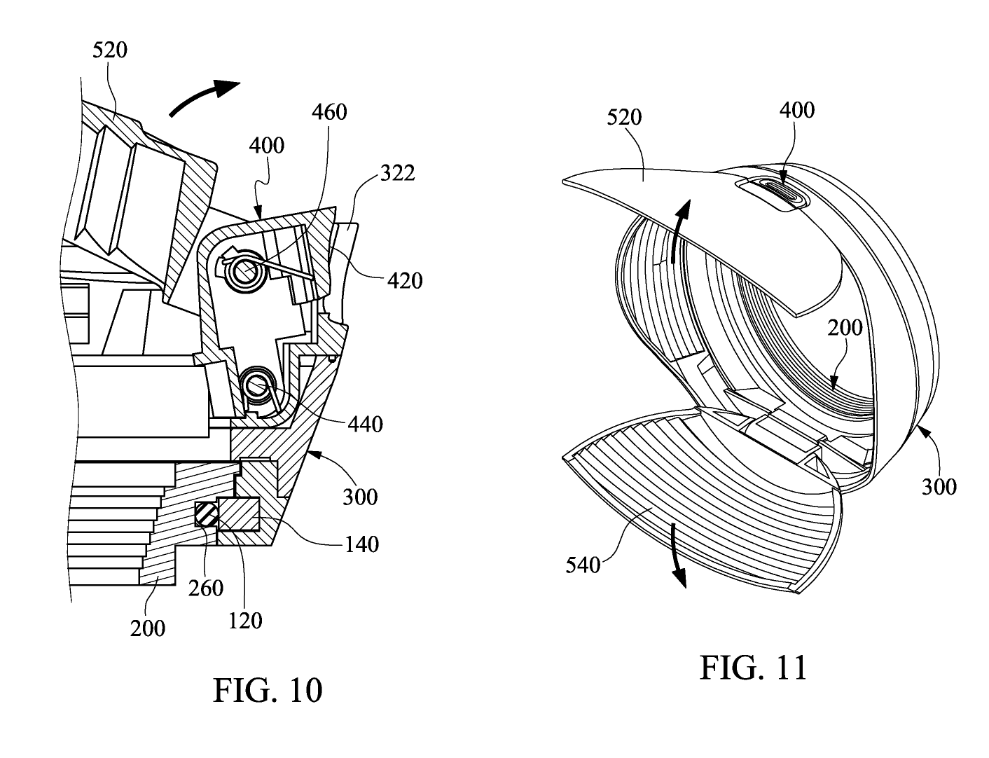

Referring to FIGS. 8 to 10, the shield 520 is pivoted from the first ring 320 of the hood device 300 by the shaft unit 460. Accordingly, the shield 540 is pivoted from the first ring 320 of the hood device 300 by the shaft unit 480.

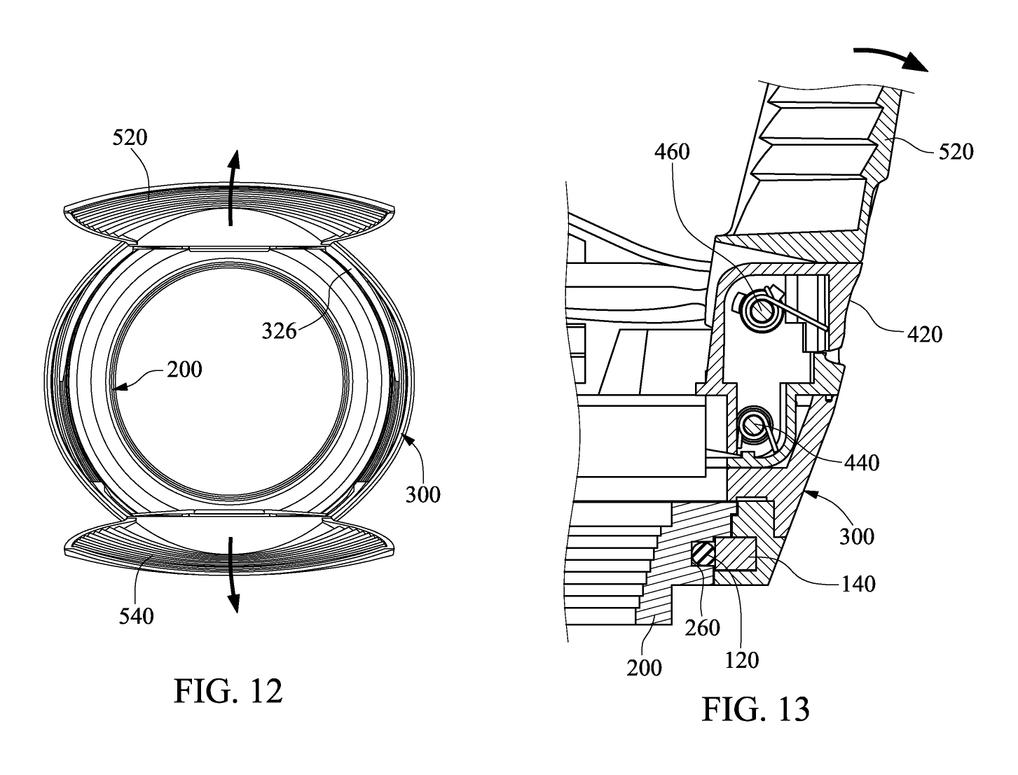

Referring to FIGS. 11 through 13, the shields 520 and 540 are in the opening position.

Manually, the shields 520 and 540 can be pivoted into the closing position shown in FIGS. 4 to 6 from the opening position shown in FIGS. 11 to 13 via the transient position shown in FIGS. 8 to 10. Each of the arched ribs 326 is preferably formed with an inclined upper (or “front”) face. During the pivoting of the shield 520 into the closing position from the opening position, the lateral edges of the shield 520 are moved on the inclined upper faces of the arched ribs 326. Thus, the lateral edges of the shield 520 are moved toward the shield 540 while they are moved toward the hood device 300. Accordingly, the button device 400 is moved into the pushed position. Then, the shield 520 is moved past peaks of the arched ribs 326. Now, the shield 520 is pivoted away from the shield 540 by the button device 400, which is in pivoted into the normal position by the shaft unit 440. Hence, the lateral edges of the shield 520 are placed beneath the arched ribs 326. That is, the shield 520 is retained in the closing position.

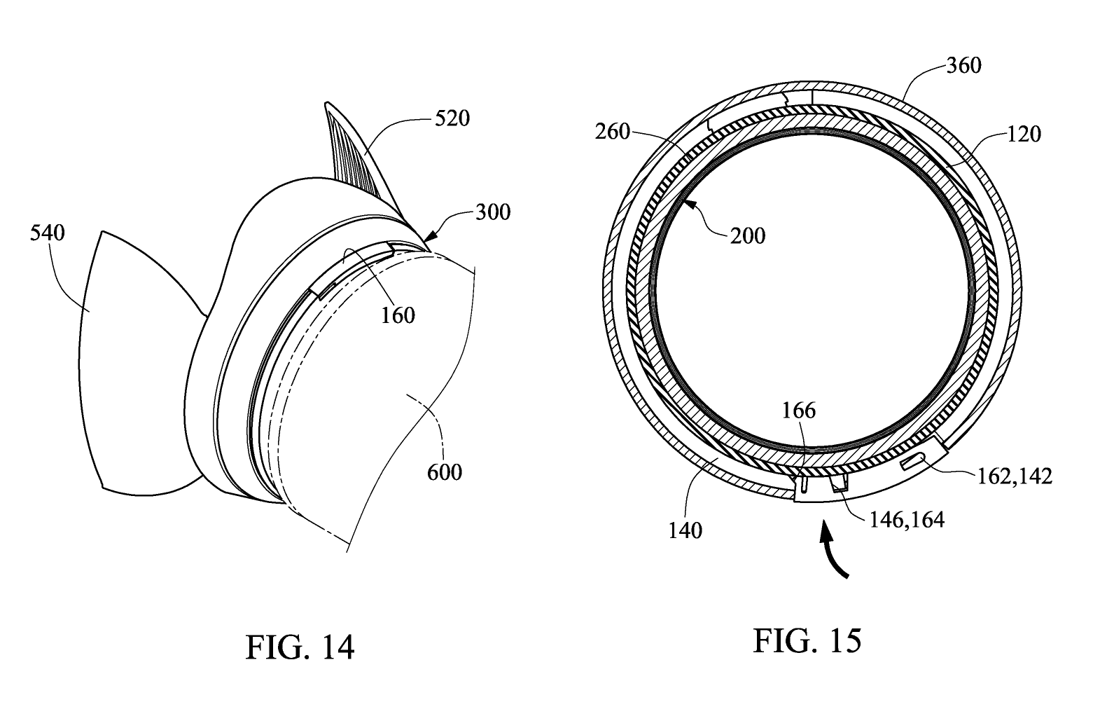

Referring to FIGS. 14 and 15, the ferrule device 100 is in the shrunk position. In detail, the boss 166 is kept in the recess 144. The lock 160 is placed against the second end of the ferrule 140. The wedge 164 is in contact with the wedge 146. The ends of the ferrule 140 are pulled close to each other by the lock 160. That is, the ferrule 140 shrinks. Thus, the ferrule device 100 is kept in position on the connecting ring 200. Accordingly, the hood device 300 is kept in position on the connecting ring 200.

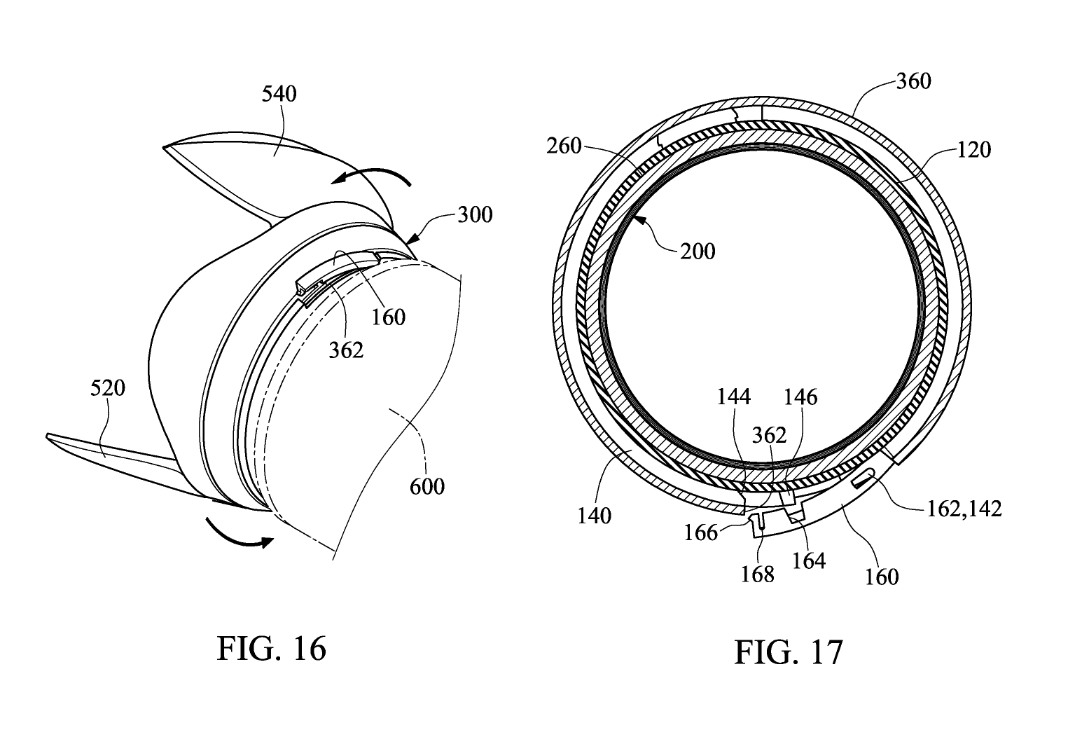

Referring to FIGS. 16 and 17, the ferrule device 100 is in the releasing position. In detail, the boss 166 is placed out of the recess 144 as the lock 160 is pivoted from the second end of the ferrule 140. The wedge 164 is detached from the wedge 146. The lock 160 allows the ends of the ferrule 140 to move from each other. That is, the ferrule 140 is allowed to expand. Accordingly, the hood device 300 is allowed to rotate on the connecting ring 200. Hence, the shields 520 and 540 can be rotated to any desired position about the axis of the barrel 600.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

1. A lens cap assembly including:
a hood device 300;
a shield device 500 for closing the hood device 300;
a connecting ring 200 for rotationally connecting the hood device 300 to a barrel 600 of a lens assembly; and
a ferrule device 100 movable between a shrunk position for preventing the hood device 300 from rotation on the barrel 600 and an expanded position for allowing the rotation of the hood device 300 on the barrel 600.

2. The lens cap assembly according to claim 1, wherein the connecting ring 200 is non-rotationally connected to the barrel 600, wherein the ferrule device 100 is rotationally connected to the connecting ring 200, wherein the hood device 300 is placed around the ferrule device 100 so that the hood device 300 is rotatable together with the ferrule device 100.

3. The lens cap assembly according to claim 2, wherein the ferrule device 100 includes a ferrule 140 placed around the connecting ring 200 and a lock 160 operable for moving the ferrule 140 between a shrunk position to prevent the ferrule 140 from rotation on the connecting ring and an expanded position to allow the rotation of the ferrule 140 on the connecting ring 200.

4. The lens cap assembly according to claim 3, wherein the ferrule 140 is a C-shaped element formed with two ends.

5. The lens cap assembly according to claim 4, wherein the ferrule 140 includes a pivot 142 near one of the ends, wherein the lock 160 includes an aperture 162 for receiving the pivot 142.

6. The lens cap assembly according to claim 5, wherein the ferrule 140 includes a wedge 146 near the other end, wherein the lock 160 includes a wedge 146 for sliding on the wedge 146 of the ferrule 140 to bring the ferrule 140 into the shrunk position from the expanded position.

7. The lens cap assembly according to claim 6, wherein the ferrule 140 includes a recess 144, wherein the lock 160 includes a boss 166 for insertion in the recess 144 to cause the lock 160 to retain the ferrule 140 in the shrunk position.

8. The lens cap assembly according to claim 7, wherein the lock 160 includes a slit 168 near the boss 166 to form an elastic leaf 169, wherein the boss 166 is formed on the elastic leaf 169, wherein the elastic leaf 169 is elastically pivoted when the boss 166 is moved into or out of the recess 144.

9. The lens cap assembly according to claim 3, wherein the hood device 300 includes a slot 362 for allowing access to the lock 160.

10. The lens cap assembly according to claim 9, wherein the shield device 500 includes at least one shield 520 pivotally connected to the hood device 300.

11. The lens cap assembly according to claim 10, including a button device 400 operable to allow movement of the shield 520 into an opening position from a closing position.

12. The lens cap assembly according to claim 11, wherein the button device 400 is movably connected to the hood device 300, wherein the shield 520 is pivotally connected to the button device 400.

13. The lens cap assembly according to claim 12, wherein the button device 400 includes a button 420 and a shaft unit 440 for pivotally connecting the button 420 to the hood device 300, wherein the shaft unit 440 tends to keep the button 420 in an un-pushed position.

14. The lens cap assembly according to claim 13, wherein the hood device 300 includes at least one rib 326 formed on an internal face, wherein the shield 520 includes at least one edge kept beneath the rib 326 in the closing position, wherein the button 420 is operable to allow the movement of the shield 520 to move the edge of the shield 520 beyond the rib 326 to allow the pivoting of the shield 520 into the opening position from the closing position.

15. The lens cap assembly according to claim 14, wherein the shield device 500 includes a shaft unit 460 for pivotally connecting the shield 520 to the button 420, wherein the shaft unit 460 tends to pivot the shield 520 into the opening position.

16. A lens cap assembly including:
a hood device 300 including at least one rib 326 formed on an internal face;
a connecting ring 200 for rotationally connecting the hood device 300 to a barrel 600 of a lens assembly;
a shield device 500 including at least one shield 520 movably connected to the hood device 300 between an opening position and a closing position, wherein the shield 520 includes at least one edge kept beneath the rib 326 in the closing position; and
a button device 400 operable to allow movement of the shield 520 into the opening position from the closing position.

17. The lens cap assembly according to claim 16, wherein the button device 400 is movably connected to the hood device 300, wherein the shield 520 is pivotally connected to the button device 400.

18. The lens cap assembly according to claim 17, wherein the button device 400 includes a button 420 and a shaft unit 440 for pivotally connecting the button 420 to the hood device 300, wherein the shaft unit 440 tends to keep the button 420 in an un-pushed position.

19. The lens cap assembly according to claim 18, wherein the button 420 is operable to move the shield 520 to move the edge of the shield 520 beyond the rib 326 to allow the pivoting of the shield 520 into the opening position from the closing position

20. The lens cap assembly according to claim 19, wherein the shield device 500 includes a shaft unit 460 for pivotally connecting the shield 520 to the button 420, wherein the shaft unit 460 tends to pivot the shield 520 into the opening position.
